(19) United States
(12) Patent Application Publication
(10) Pub. No.: US 2024/0094817 A1
(43) Pub. Date: Mar. 21, 2024

(54) PROVISION OF FEEDBACK TO AN ACTUATING OBJECT

(71) Applicant: Hewlett-Packard Development Company, L.P., Spring, TX (US)

(72) Inventor: Hsiang-Ta Ke, Taipei City (TW)

(73) Assignee: Hewlett-Packard Development Company, L.P., Spring, TX (US)

(21) Appl. No.: 17/768,890

(22) PCT Filed: Oct. 28, 2019
(86) PCT No.: PCT/US2019/058284

§ 371 Date: Apr. 14, 2022

(51) Int. Cl. G06F 3/01; G02B 27/01; G06F 3/0482

(52) U.S. Cl. CPC G06F 3/016; G02B 27/017; G06F 3/011; G06F 3/017; G06F 3/0482; G06F 2203/014

(57) ABSTRACT

Techniques for providing feedback to an actuating object are described. In an example, a device may provide a user interface having a virtual menu button that can be actuated based on a position of an object. If the virtual menu button is determined to be actuated, the device provides a haptic feedback to the object.

### BACKGROUND

A head-mountable device (HMD) is a display device that can be worn on the head or as part of a headgear of a user. The HMD may provide a simulated environment, such as an extended reality (XR) environment to a user, such as a wearer of the HMD. The XR environment may be, for example, a virtual reality (VR) environment, a mixed reality (MR) environment, or an augmented reality (AR) environment. The user may be allowed to interact with the simulated environment using a user interface (UI) having menu options that can be actuated by the user.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a head-mountable device (HMD) to provide haptic feedback to an actuating object in a simulated environment, according to an example implementation of the present subject matter;

FIG. 2 illustrates a wearable computing device to provide haptic feedback to an actuating object, according to an example implementation of the present subject matter;

FIG. 3 illustrates a perspective view of an HMD to provide haptic feedback to an actuating object, according to an example implementation of the present subject matter;

FIG. 4 illustrates provision of haptic feedback to an actuating object by a feedback generator, according to an example implementation of the present subject matter;

FIG. 5 illustrates an image provided by an HMD, according to an example implementation of the present subject matter: and

FIG. 6 illustrates a computing environment, implementing a non-transitory computer-readable medium for provision of feedback to an actuating object, according to an example implementation of the present subject matter.

### DETAILED DESCRIPTION

Head-mountable devices (HMDs) are used in various applications where simulated environments are to be provided, such as gaming applications, engineering simulation applications, and aviation applications. The HMD may display images corresponding to the simulated environment provided by it. For instance, in case of a racing game environment, a wearer of the HMD may view a racing track and racing cars in front of him.

The HMD may allow a user to interact with the simulated environment. To facilitate the interaction, the HMD may display a user interface (UI) having various options that can be selected by the wearer. For instance, in the case of the racing game environment, a user interface having several racing cars as options may be provided for selection of a racing car. The options may be provided as virtual buttons that can be actuated by the wearer. In response to selection of a virtual button, an image corresponding to the selection may be displayed. The image corresponding to the selection may be, for example, an image in which the virtual button is modified, such as darkened or highlighted, to indicate its selection.

Since the virtual button cannot be physically actuated, the user may not perceive that the virtual button has been actuated until the corresponding image is displayed. Further, the user may have to attempt to actuate the virtual button several times, such as by repeating a gesture several times, until the corresponding image is displayed. As will be understood, this degrades the user experience when interacting with the HMD.

The present subject matter relates to provision of feedback to an actuating object.

In accordance with an example implementation of the present subject matter, an HMD includes a display device that can provide an image having a user interface (UI). The UI may correspond to a simulated environment provided by the HMD or a host device, which may be an external computing device connected to the HMD. In an example, the UI may be provided as a virtual image, which may appear as if it is at a comfortable viewing distance in front of a wearer of the HMD. The UI may include a virtual menu button that can be actuated.

A controller may determine if the virtual menu button has been actuated. The controller may be, for example, a microcontroller embedded in the HMD. In an example, the controller may determine that the virtual menu button has been actuated based on a position of the object relative to the HMD. For instance, the virtual menu button may be determined to be actuated if the object is in a predetermined region in front of the HMD or if the object is at a distance less than a threshold distance from the HMD. In another example, the controller may determine the actuation of the virtual menu button to have occurred upon receiving an actuation indication from the host device. The host device in turn may determine if the virtual menu button has been actuated based on the position of the object relative to the HMD. For example, the host device may receive information indicative of position of the object, such as images of the object and distance of the object, from the HMD to determine if the virtual menu button is actuated.

A feedback generator provides a haptic feedback to the object if it is determined that the virtual menu button is actuated. The haptic feedback may emulate a sensation similar to a tactile response sensed by the object while actuating a physical switch, such as a dipswitch of a car. The feedback generator may be, for example, an ultrasonic feedback generator, which provides the haptic feedback using ultrasound. Further, the feedback generator may be coupled to the controller for receiving a command for generating ultrasound. For instance, the feedback generator may include a plurality of ultrasonic transmitters, which convert electrical signals into ultrasound. Accordingly, upon receiving electrical signals from the controller, the transmitters may generate ultrasound directed towards the object to provide the haptic feedback.

The present subject matter provides an efficient feedback providing mechanism for HMDs. For instance, since the user is provided with a haptic feedback on actuation of virtual menu options, the user experience when interacting with simulated environments displayed by the HMDs is enhanced.

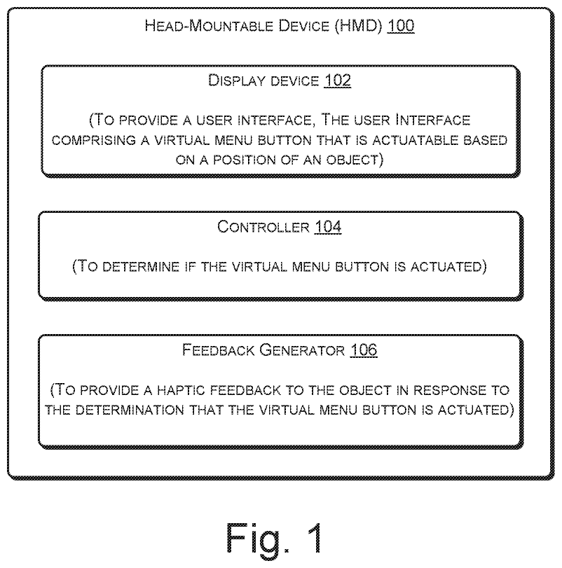

The present subject matter is further described with reference to FIGS. 1-6. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates an HMD 100 to provide a haptic feedback to an object in a simulated environment, according to an example implementation of the present subject matter. The HMD 100 can be worn on the head or as part of a headgear of a user. The HMD 100 may include a display device 102 that can provide a user interface (UI). The UI may be provided as an image or as part of an image provided by the display device 102.

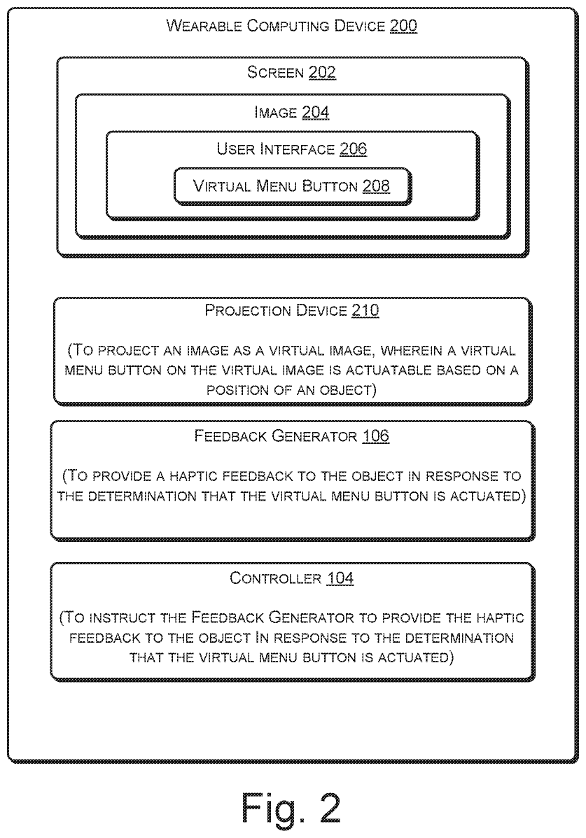

In an example, the image may be a virtual image corresponding to a first image displayed on a screen of the display device 102. To provide the virtual image, the display device 102 may include a projection device, as will be explained with reference to FIG. 2. In another example, the image may be the first image, which is displayed on the screen, and the display device 102 may not include the projection device.

The image may correspond to a simulated environment provided by a host device (not shown in FIG. 1), which may be an external computing device, such as laptop, desktop, or server, that is connected to the HMD 100. For example, the host device may generate the simulated environment and transmit the first image to the HMD 100. In another example, the simulated environment may be provided by the HMD 100.

An example of the simulated environment is of a racing game. In accordance with the example, the corresponding image may include a racing track and vehicles on the racing track. Further, the UI may allow interaction with the simulated environment. To allow the interaction, the UI may include a menu option that can be selected. For instance, the UI corresponding to the racing game may include a menu option corresponding to a racing car to be used for the racing game. Accordingly, the selection of the menu option may cause usage of the corresponding racing car for the racing game. In an example, the menu option displayed may resemble a physical button. Accordingly, the menu option may be referred to as a virtual menu button. Further, the selection of the menu option may be referred to as the actuation of the virtual menu button.

To actuate the virtual menu button, the user of the HMD 100 may utilize an object, which may be, for example, a finger of the user. The virtual menu button may be actuated based on a position of the object. For instance, the virtual menu button may be actuated by positioning the object in a region corresponding to the virtual menu button.

To determine actuation of the virtual menu button, the HMD 100 may include a controller 104. The controller 104 may be implemented as a microprocessor, a microcomputer, a microcontroller, a digital signal processor, a central processing unit, a state machine, a logic circuitry, or a device that manipulates signals based on operational instructions. Among other capabilities, the controller 104 may fetch and execute computer-readable instructions stored in a memory (not shown in FIG. 1), such as a volatile memory or a non-volatile memory, of the HMD 100.

In an example, the controller 104 may determine actuation of the virtual menu button based on a position of the object relative to the HMD 100. For instance, if the object is in a predetermined region relative to the HMD 100, the controller 104 may determine that the virtual menu button is actuated. In another example, the controller 104 may determine that the actuation of the virtual menu button has occurred in response to receiving an actuation indication from the host device. The host device may generate the actuation indication if it determines that the virtual menu button is actuated. The host device may determine the actuation based on the position of the object relative to the HMD 100.

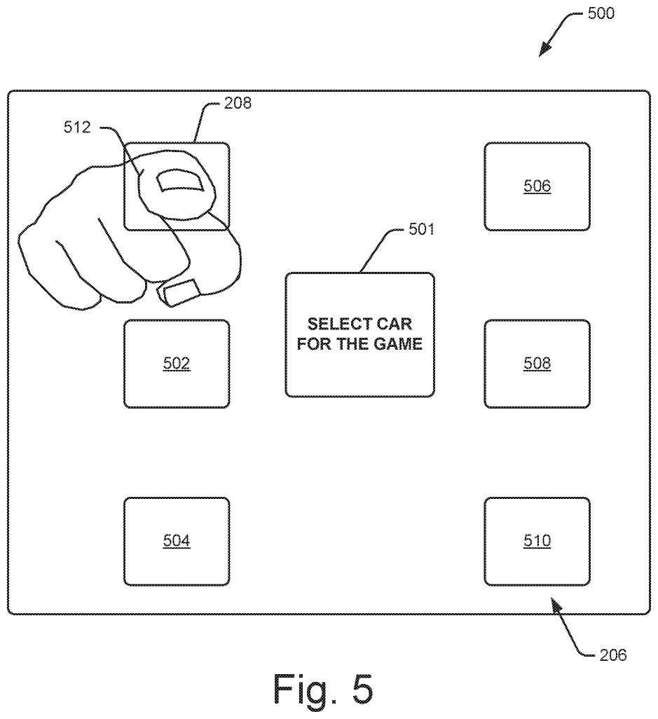

In an example, the actuation of the virtual menu button may be determined based on a virtual object (not shown in FIG. 1) that corresponds to the object. The virtual object may be provided on images provided by the display device 102. Further, a position of the virtual object may be adjusted in the images based on movement of the object. Accordingly, the actuation of the virtual menu button may be determined based on a position of the virtual object on the image. For instance, if the virtual object overlaps with the virtual menu button, it may be determined that the virtual menu button is actuated. The virtual object and determination of actuation based on the virtual menu button will be explained in greater detail with reference to FIG. 5.

The HMD 100 further includes a feedback generator 106. The feedback generator 106 may provide a haptic feedback to the object if it is determined that the virtual menu button is actuated. The haptic feedback may emulate a tactile feedback received when a physical switch, such as a dipswitch of a car or a push button, is actuated, thereby enhancing the user experience and avoiding multiple actuations of the virtual menu button by the user. In an example, the feedback generator 106 includes an ultrasonic transmitter, which generates ultrasound based on electrical signals.

FIG. 2 illustrates a wearable computing device 200 to provide haptic feedback to an actuating object, according to an example implementation of the present subject matter. The wearable computing device 200 may be implemented as an HMD, such as the HMD 100.

The wearable computing device 200 includes a screen 202. The screen 202 may be, for example, a liquid crystal display (LCD) display, a light emitting diode (LED) display, an organic LED (©LED) display, or the like. The screen 202 may display an image 204 having a UI 206. The image 204 may be the first image (explained above). The UI 206 may be similar to the UI explained with reference to FIG. 1. The UI 206 may include a virtual menu button 208.

In an example, the wearable computing device 200 may also include a projection device 210. The projection device 210 and the screen 202 may be part of the display device 102. The projection device 210 may project the image 204 displayed by the screen 202 as a virtual image. In an example, the projection device 210 may include an eyepiece, which may be disposed such that the projection device 210 is between an eye of a wearer and the screen 202 when the wearable computing device 200 is worn by the wearer. The eyepiece may include an optical lens, such as an aspheric lens. Further, the eyepiece may magnify and project the image 204 displayed by the screen 202 in the eye of the wearer. Therefore, the user may see, through the eyepiece, a magnified virtual image of the image 204 displayed by the screen 202. Accordingly, the virtual image may appear bigger than the image 204 displayed on screen 202 and as if it is at a distance in front of the wearable computing device 200, for comfortable viewing by the wearer.

Since the virtual image corresponds to the image 204, the virtual image includes the UI 206 and the virtual menu button 208. The virtual menu button 208 on the virtual image can be actuated based on position of an object, such as a finger of the wearer. For instance, the wearer may point with his finger in front of the wearable computing device 200 to a region where the virtual menu button 208 is visible to him. In addition, the wearer may perform a gesture to actuate the virtual menu button 208. The gesture may be, for example, bringing the finger closer to the wearable computing device 200, which is similar to an action performed to actuate a physical switch.

The wearable computing device 200 may further include the controller 104 and the feedback generator 106. The controller 104 may determine actuation of the virtual menu button 208 on the virtual image. In an example, the controller 104 may determine that the virtual menu button 208 is actuated if the object is pointing to the region of the virtual image having the virtual menu button 208. In an example, to determine the region of the virtual image to which the object is pointing, the controller 104 may determine the position of the object relative to the wearable computing device 200. The position of the object, in turn, may be determined based on an image of the object captured by a camera of the wearable computing device 200, a distance of the object from the wearable computing device 200, or both.

In an example, the actuation of the virtual menu button 208 based on the position of the object may be determined by a host device connected to the wearable computing device 200. Based on the determination, the host device may send an actuation indication to the controller 104. Upon receiving the actuation indication, the controller 104 may determine that the actuation of the virtual menu button has occurred.

In response to determining that the virtual menu button 208 is actuated (by itself or based on the actuation indication), the controller 104 may instruct the feedback generator 106 to provide the haptic feedback to the object. Accordingly, the feedback generator 106 may generate ultrasound to provide the haptic feedback to the object.

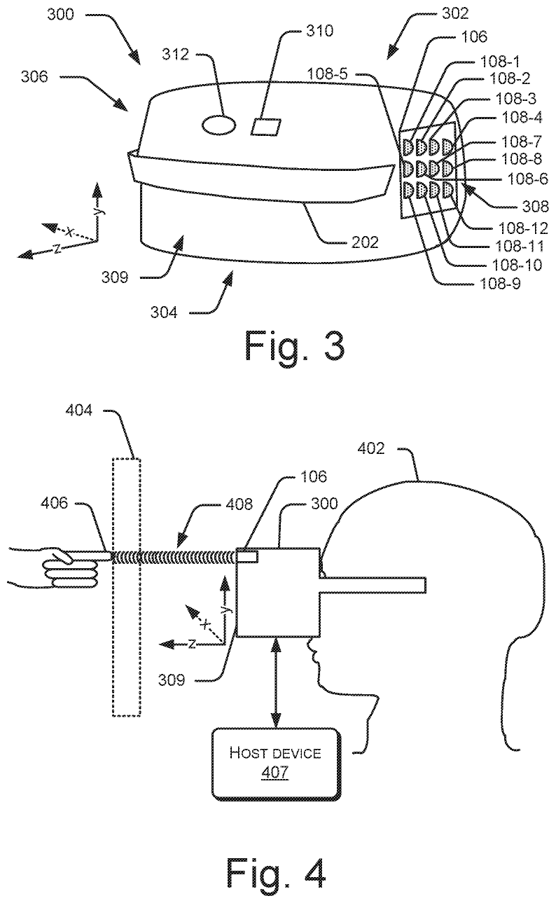

The various aspects of the present subject matter will be explained in greater detail with reference to FIGS. 3-6 below:

FIG. 3 illustrates a perspective view of an HMD 300 to provide haptic feedback to the object, according to an example implementation of the present subject matter. The HMD 300 may correspond to the HMD 100 or the wearable computing device 200.

The HMD 300 includes a body 302. The body 302 may be appropriately shaped such that it can be mounted in front of a face of a user, interchangeably referred to as a wearer. For instance, the body 302 may include a central portion 304 that may be disposed in front of eyes of the user. The body 302 may also include a first lateral portion 306 and a second lateral portion 308 on either side of the central portion 304 in a lateral direction. The lateral portions 306 and 308 may be disposed in front of the temple region of the user.

A surface of the body 302 that is to be in front of the face of the user may be referred to as a rear surface (not visible in FIG. 3) of the body 302. Further, a surface of the HMD 300 that is opposite the rear surface, i.e., the surface that is to be away from the face of the user may be referred to as a front surface 309 of the body 302. The front surface 309 may be the surface that faces the object that actuates the virtual menu button 208.

On the body 302, the screen 202 may be disposed. The screen 202 may be disposed in a central portion 304 of the front surface 309. In an example, the screen 202 may be provided in the form of a strip and may extend along the central portion 304. The screen 202 may display images corresponding to a simulated environment provided by the host device. The images displayed may include, for example, still images, images from videos, animations, and the like corresponding to the simulated environment.

The HMD 300 may also include a camera 310. In an example, the camera 310 may be disposed above the screen 202 and on the central portion 304. In other examples, the camera 310 may be disposed below the screen 202 or on the screen 202. The camera 310 may be a video camera, such as a webcam. Accordingly, the camera 310 may be utilized to track movement of objects in front of the HMD 300. For instance, the camera 310 may track movement and position of the object, such as the finger of the user, in front of the HMD 300. In an example, the camera 310 may have a field of view corresponding to a size of the virtual image provided by the projection device 210 (not shown in FIG. 3). Accordingly, the movement of the object relative to the virtual image can be monitored by the camera 310.

The camera 310 may facilitate determination of the position of the object relative to the HMD 300. In an example, data, such as images of the object, provided by the camera 310 may facilitate determination of the relative position of the object in two dimensions. For instance, the images of the object provided by the camera 310 may facilitate determination of x and y coordinates of the object relative to the HMD 300.

The HMD 300 may further include a distance sensor 312 that can determine a distance between the object and the HMD 300. The distance sensor 312 may be disposed above the screen 202 and on the central portion 304. In another example, the distance sensor 312 may be disposed below the screen 202 and on the central portion 304. The distance sensor 312 may determine distance of the object that is in front of the HMD 300. An example object in front of the HMD 300 may be the object that is to actuate the virtual menu button 208 (not shown in FIG. 3). The distance sensor 312 may include, for example, an infrared (IR) sensor, which can emit infrared waves and determines the distance of the object from the IR sensor based on reflected infrared waves from the object. In an example, the distance of the object from the HMD 300, as determined by the distance sensor 312, may be a z coordinate of the object relative to the HMD 300. Accordingly, the distance sensor 312 may facilitate determination of the position of the object relative to the HMD 300. Further, using a combination of the data provided by the camera 310 and the distance sensor 312, the controller 104 may determine a three-dimensional (3D) position, i.e., x, y, and z coordinates, of the object relative to the HMD 300.

In an example, the position of the object relative to the HMD 300, as determined using the input from the camera 310, the distance sensor 312, or both may be utilized by the controller 104 to determine the actuation of the virtual menu button 208. In another example, the determination of actuation based on the position of the object relative to the HMD 300 may be performed by the host device (not shown in FIG. 3). The position of the object relative to the HMD 300 may be interchangeably referred to as a relative position of the object with respect to the HMD 300 or as a relative position. The determination based on the relative position is explained below with the help of a few examples:

In an example, the determination may be based on object images, which are images of the object provided by the camera 310. For instance, if the (x, y) position of the object relative to the HMD 300 (which may be determined based on the object images) is in a predetermined range, the controller 104 may determine that the virtual menu button 208 is actuated. The predetermined range of (x, y) coordinates may correspond to the size of the virtual image or the size of the virtual menu button 208 in the virtual image. For instance, the predetermined range of (x, y) coordinates may be (x, y) coordinates of four corners of the virtual image or of four corners of the virtual menu button 208 in the virtual image.

In another example, the determination of actuation may be based on the distance, i.e., z coordinate, of the object from the HMD 300, as determined by the distance sensor 312. For instance, the virtual menu button 208 may be determined to be actuated if the distance between the object and the HMD 300 is lesser than a threshold distance. Accordingly, the virtual menu button 208 may be determined to be actuated if the object is brought closer to the HMD 300.

In a further example, the determination of actuation may be based on the 3D position of the object relative to the HMD 300. Accordingly, data from both the camera 310 and the distance sensor 312 may be utilized for determining the actuation.

If the determination of actuation based on the relative position is to be performed by the host device, the controller 104 may transmit the object images, the distance between the object and the HMD 300, or both to the host device. Based on the received information, the host device may perform the determination of actuation. Upon determination of the actuation, the host device may transmit an actuation indication to the controller 104, based on which the controller 104 determines that the actuation is performed.

In response to the determination of the actuation, the controller 104 may instruct the feedback generator 106 to generate the haptic feedback. The feedback generator 106 may be disposed, for example, on the second lateral portion 308. To provide the haptic feedback, the feedback generator 106 may utilize ultrasound. In an example, the feedback generator 106 may generate ultrasound that causes disturbance in the air. The disturbance may be incident on the object when the ultrasound crosses the object. For instance, if the object is a finger of a user, a shear wave may be triggered on the finger, which creates a feeling of movement on the finger. Such a movement may be similar to the movement experienced when a physical button, such as a dipswitch of a car, is actuated.

In an example, the feedback generator 106 may include a plurality of ultrasonic transmitters, which convert electrical signals into ultrasound. The ultrasonic transmitters may be distributed on the front surface 309. For instance, the ultrasonic transmitters may be arranged in the form of an array. In an example, the array of transmitters may include 12 transmitters 108-1-108-12 arranged in a rectangular pattern of three rows and four columns. Further, a first column of three transmitters 108-1, 108-5, 108-9 may be nearest to the central portion 304, while a fourth column of transmitters 108-4, 108-8, 108-12 may be farthest from the central portion 304. Further, a second column of transmitters 108-2, 108-6, 108-10 and a third column of transmitters 108-3, 108-7, 108-11 may be disposed between the first column and the fourth column.

In an example, instead of the second lateral portion 308, the feedback generator 106 may include a plurality of ultrasonic transmitters disposed on the first lateral portion 306. The arrangement of the ultrasonic transmitters may be similar to that of ultrasonic transmitters 108-1-108-12 as explained above. In a further example, the feedback generator 106 may include ultrasonic transmitters on the first lateral portion 306 and the second lateral portion 308. Instead of, or in addition to, the ultrasonic transmitters on the lateral portions 306, 308 the feedback generator 106 may include ultrasonic transmitters disposed on the central portion 304.

The ultrasonic transmitters of the feedback generator 106 may be selectively activated to direct ultrasound to the actuating object, as will be explained below.

FIG. 4 illustrates provision of haptic feedback to the actuating object by the feedback generator 106, according to an example implementation of the present subject matter. The actuating object may be a finger of a user. Here, a side-view of a user 402 wearing the HMD 300 is shown. Further, the origin of an (x, y, z) coordinate system is shown slightly offset from the HMD 300 to clearly illustrate the HMD 300. However, the origin may be present on the HMD 300.

As explained earlier, a virtual image 404 of the image displayed by the screen 202 may be provided to the user 402. The virtual image 404 may include the UI 206, having the virtual menu button 208 (not shown in FIG. 4). The virtual menu button 208 may be actuated by a finger 406 of the user 402. The actuation of the virtual menu button 208 may be determined based on (x, y) coordinates, z coordinate, or (x, y, z) coordinates of the object relative to the HMD 300. As explained earlier, the (x, y) coordinates may be determined based on the input from the camera 310 and the z coordinate may be determined based on the input from the distance sensor 312. Further, as explained earlier, the determination of the actuation based on the relative position of the object may be performed by the controller 104 (not shown in FIG. 4) or by the host device 407.

In response to the determination of the actuation, the feedback generator 106 may provide the haptic feedback to the finger 406. The haptic feedback may be provided, for example, by transmitting ultrasound signals 408 to the finger 406. In an example, the feedback generator 106 may direct the ultrasound signals 408 towards the object to ensure that the haptic feedback is provided to the finger 406.

To direct the ultrasound signals 408 to the finger 406, the relative position of the finger 406, as determined by the controller 104 or the host device 407, may be utilized. Further, based on the relative position of the finger 406, the controller 104 may selectively activate an ultrasonic transmitter of the feedback generator 106 to transmit the ultrasound signal 408 to the object. For instance, if the finger 406 is in front of the central portion 304 and above the HMD 300 (positive y-coordinate), the controller 104 may activate the ultrasonic transmitters 108-1 and 108-2, which are nearer to the central portion 304 and present at the first row of the array, to transmit ultrasound to the finger 406. In another example, if the finger 406 is in front of an end of the second lateral portion 308 and below the HMD 300, the ultrasonic transmitters 108-11 and 108-12, which are near the end of the second lateral portion 308 and present at the last row of the array, may be activated to transmit ultrasound to the finger 406.

In an example, if the relative position of the finger 406 and the actuation based on the relative position are determined by the host device 407, the host device 407, in addition to transmitting the actuation indication, may transmit an indication of the relative position to the controller 104. Accordingly, based on the relative position received, the controller 104 may selectively activate the ultrasonic transmitters. In another example, the host device 407 may transmit to the controller 104 an indication of the ultrasonic transmitters to be activated based on the relative position, so that the controller 104 can selectively active the indicated ultrasonic transmitters.

Similar to the activation of the ultrasonic transmitters on the second lateral portion 308, the ultrasonic transmitters on the first lateral portion 306 and on the central portion 304 may also be activated selectively based on the relative position of the finger 406. The provision of the plurality of ultrasonic transmitters and their distribution on the front surface 309 ensures that the haptic feedback may be provided to the finger 406 regardless of its position relative to the HMD 300.

FIG. 5 illustrates an image 500 provided by the HMD 300, according to an example implementation of the present subject matter. The image 500 may be the virtual image 404 viewed by the user 402. The image 500 may include the UI 206 that facilitates interaction of the user 402 with the simulated environment. The UI 206 may be, for example, a UI for selection of a racing car to be used for playing a racing game provided by the HMD 300. Accordingly, an information box 501 may be provided prompting the user 402 to select a car for the game. In addition, the UI 206 may include the virtual menu button 208 and other virtual menu buttons 502, 504, 506, 508, and 510. Each virtual menu button may correspond to an option provided by the HMD 300 for interaction with the simulated environment. For instance, each virtual menu button may correspond to a car that can be used for playing the racing game.

In an example, in addition to the UI 206, the HMD 300 may provide a virtual object 512 on the image 500. The virtual object 512 may correspond to an object, such as the finger 406, that is used to actuate a virtual menu button. A position of the virtual object 512 on the image 500 may correspond to a position of the object relative to the HMD 300. For instance, consider that, prior to the image 500, another image having the UI 206 and the virtual object 512 was displayed. Now, if the object moves slightly towards right-hand side of the HMD 300, the virtual object 512 is slightly displaced to the right-hand side in the subsequent image, i.e., the image 500, as compared to its position in the previous image.

To track the movement and the relative position of the object, the HMD 300 may utilize the camera 310. The tracking of the movement of the object and the corresponding adjustment of the position of the virtual object 512 in the images provided by the HMD 300, according to an example, is described below:

In operation, the controller 104 fetches multiple images captured by the camera 310. The images may be converted into grayscale images. For the conversion, the controller 104 may utilize an RGB-to-YUV transformation. Subsequently, a contour of the object may be obtained, for example, using a contour detection technique or an edge detection technique. Further, the edge detection technique may utilize a canny edge detector or a sobel operator. Upon detecting the object, the position of the virtual object 512 may be dynamically adjusted in the images provided by the HMD 300 based on the movement of the object. Thus, the position of the virtual object 512 depends on the relative position of the object with respect to the HMD 300.

In addition to moving the virtual object 512 based on the movement of the object in the (x, y) plane, the HMD 300 may simulate movement of the virtual object 512 in the z axis. The simulated movement in the z axis may correspond to movement of the object relative to the HMD 300 in the z axis. Accordingly, the user 402 may perceive that the virtual object 512 is approaching him if he moves the object closer to the HMD 300 and vice versa. The movement of the virtual object 512 in the z axis may be simulated, for example, by progressively enlarging the size of the virtual object 512 in subsequent images if the object is approaching the HMD 300. Similarly, if the object is moving away from the HMD 300, the virtual object 512 may be progressively reduced in size in the subsequent images. The movement of the object in the z axis may be determined based on the input from the distance sensor 312, as explained earlier.

Since the virtual object 512 moves in accordance with the movement of the object, the virtual object 512 allows the user 402 to determine a direction in which the user 402 is to move the object to select the virtual menu button 208. For instance, if the user 402 wants to actuate the virtual menu button 208, and finds that the virtual object 512 is positioned slightly to the left-hand side of the virtual menu button 208, the user 402 may move the object towards the right-hand side. The user 402 may continue to move the object towards the right-hand side until the virtual object 512 is on top of the virtual menu button 208, as illustrated in FIG. 5. Accordingly, the virtual object 512 acts as a visual feedback to the user 402 for actuation of the virtual menu buttons.

In an example, the actuation of the virtual menu button 208 may be determined by the controller 104 based on the position of the virtual object 512. This is because, as explained above, if the user 402 intends to actuate the virtual menu button 208, the user 402 may move the object such that the virtual object 512 overlaps with the virtual menu button 208. Accordingly, to determine the actuation of the virtual menu button 208, the controller 104 may determine the position of the virtual object 512 relative to the virtual menu button 208. For instance, if the position of the virtual object 512 overlaps with the position of the virtual menu button 208 on the image 500, the controller 104 may determine that the user 402 intends to actuate the virtual menu button 208. Accordingly, an action corresponding to the virtual menu button 208 may be performed. For instance, an image corresponding to the virtual menu button 208 or an image in which the virtual menu button 208 is highlighted to indicate its selection may be displayed by the HMD 300. In addition, the controller 104 may instruct the feedback generator 106 (not shown in FIG. 5) to provide the haptic feedback to the object. Similarly, if the position of virtual object 512 overlaps with the position of another virtual menu button, such as the virtual menu button 502, the controller 104 determines that the user 402 intended to actuate the other virtual menu button 502 and provide a haptic feedback to the object.

In an example, the controller 104 may control the feedback generator 106 such that it provides different haptic feedbacks for actuation of different virtual menu buttons. The haptic feedbacks may differ from each other, for example, in terms of intensity. For instance, a haptic feedback of a lesser intensity may be provided for actuation of the virtual menu button 208, while haptic feedback of a greater intensity may be provided for actuation of the virtual menu button 502. In an example, intensity of the haptic feedback of may be varied by varying the frequency of the ultrasound signal. Accordingly, if the object is the finger 406, the user 402 may experience a greater force on the finger 406 for the actuation of the virtual menu button 502 than that experienced for the actuation of the virtual menu button 208.

In an example, to determine the actuation of the virtual menu button 208, the controller 104 may also check for a change in the distance of the object from the HMD 300. The change in the distance may be checked for, because once the user 402 has moved the object such that the virtual object 512 overlaps with the virtual menu button 208, the user 402 may move the object towards the HMD 300 to mimic the actuation of a physical button. Thus, the change in the distance of the object from the HMD 300 may confirm the intention to actuate the virtual menu button 208. In an example, the actuation may be determined if a change in the distance of the object is greater than a threshold distance, such as 10 cm.

In an example, the intensity of the haptic feedback can be varied for change in distance of the object from the HMD 300. For instance, as the finger 406 is brought closer to the HMD 300, the intensity of the feedback may be increased, causing an increased resistance on the finger 406 for a greater actuation. This emulates the force experienced on a finger when a physical button is pushed.

In the above explanation, the provision of the virtual object 512, the adjustment of the position of the virtual object 512 on images based on movement of the object, and determination of actuation based on the position of the virtual object 512 are explained as being performed by the controller 104. However, in some examples, one, some, or all of these steps may be performed by the host device 407.

In an example, instead of the position of the virtual object 512, the position of the object relative to the HMD 100 may be used to determine the actuation of the virtual menu button 208. For instance, the (x, y) coordinates of the object relative to the HMD 300 may be compared against the (x, y) coordinates of the virtual menu button 208. If there is an overlap, the controller 104 may determine that the virtual menu button 208 is actuated. In addition to the overlap, the change in the distance of the object from the HMD 300, as explained above, may also be considered for determining the actuation.

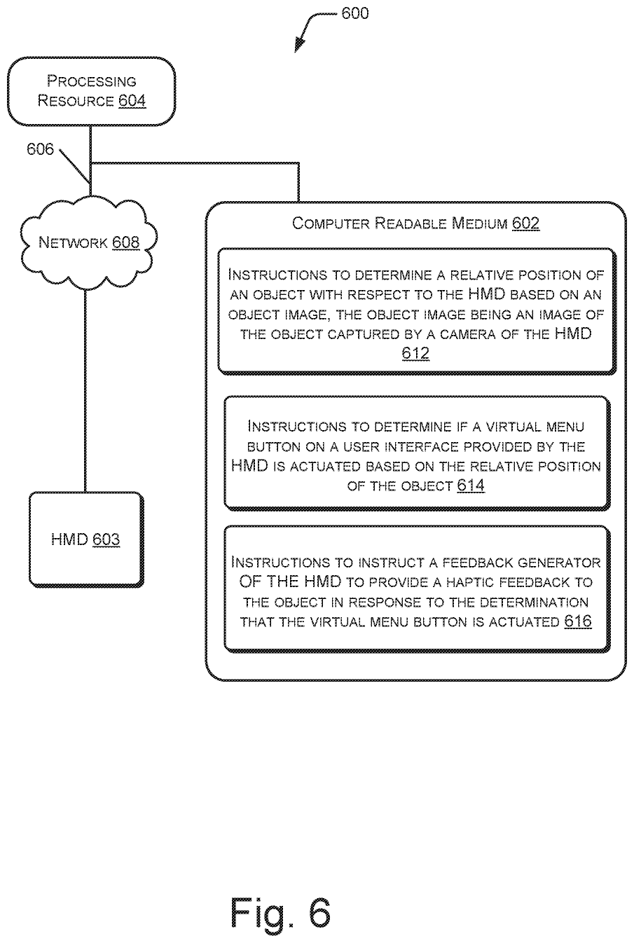

FIG. 6 illustrates a computing environment, implementing a non-transitory computer-readable medium for provision of feedback to an actuating object, according to an example implementation of the present subject matter

In an example, the non-transitory computer-readable medium 602 may be utilized by an HMD 603, which may correspond to the HMD 100, or a host device, such as the host device 407, connected to the HMD 603. The HMD 603 may be implemented in a public networking environment or a private networking environment. In an example, the computing environment 600 may include a processing resource 604 communicatively coupled to the non-transitory computer-readable medium 602 through a communication link 606.

In an example, the processing resource 604 may be implemented in a device, such as the HMD 603 or the host device. The non-transitory computer-readable medium 602 may be, for example, an internal memory device of the HMD 603 or the host device. In an implementation, the communication link 606 may be a direct communication link, such as any memory read/write interface. In another implementation, the communication link 606 may be an indirect communication link, such as a network interface. In such a case, the processing resource 604 may access the non-transitory computer-readable medium 602 through a network 608. The network 608 may be a single network or a combination of multiple networks and may use a variety of different communication protocols. The processing resource 604 and the non-transitory computer-readable medium 602 may also be communicatively coupled to the HMD 603 over the network 608.

In an example implementation, the non-transitory computer-readable medium 602 includes a set of computer-readable instructions to provide feedback, such as a haptic feedback, to an actuating object. The set of computer-readable instructions can be accessed by the processing resource 604 through the communication link 606 and subsequently executed to perform acts to provide feedback to the actuating object.

Referring to FIG. 6, in an example, the non-transitory computer-readable medium 602 includes instructions 612 that cause the processing resource 604 to determine a relative position of an object with respect to the HMD 603 based on an image of the object captured by a camera of the HMD 603. The image of the object captured by the camera may be referred to as an object image. The object may be the finger 406 and the camera may be the camera 310.

In an example, the relative position may be determined based on a distance between the object and the HMD 603. The distance may be received from a distance sensor of the HMD 603, which may correspond to the distance sensor 312.

The non-transitory computer-readable medium 602 includes instructions 614 that cause the processing resource 604 to determine if a virtual menu button on a user interface provided by the HMD 603 is actuated. The user interface may be the user interface 206 and the virtual menu button may be the virtual menu button 208. The virtual menu button may be determined to be actuated based on the relative position of the object with respect to the HMD 603. For instance, if the object is in a region in which the virtual menu button is provided, it may be determined that the virtual menu button is actuated.

In an example, the virtual menu button may be determined to be actuated based on a change in distance of the object with respect to the HMD 603. For instance, as explained earlier, if the object has moved towards the HMD 603 by more than a threshold distance, the virtual menu button may be determined to be actuated.

The non-transitory computer-readable medium 602 further includes instructions 616 that cause the processing resource 604 to instruct a feedback generator of the HMD 603 to provide a haptic feedback to the object in response to the determination that the virtual menu button is actuated. The feedback generator may be the feedback generator 106.

In an example, if the actuation is determined by the host device, which is external to the HMD 603, the host device may instruct a controller of the HMD 603 to activate the feedback generator. Based on the instruction from the host device, the controller activates the feedback generator. Accordingly, the instruction to the controller acts as the instruction to the feedback generator to provide the haptic feedback. In another example, the host device may directly instruct the feedback generator.

The feedback generator may include a plurality of ultrasonic transmitters distributed on a surface of the HMD 603 that is to face the object, such as the front surface 309. Further, to activate the feedback generator, the instructions are executable by the processing resource 604 to selectively activate an ultrasonic transmitter to provide the haptic feedback based on a position of the object relative to the HMD 603. In an example, if the relative position of the object is determined by the host device, the host device may transmit the relative position to the controller. Based on the relative position, the controller may determine the ultrasonic transmitter to be activated. In another example, the host device may provide an indication of the ultrasonic transmitter to be activated to the controller based on the relative position of the object. In a further example, the host device may directly activate the ultrasonic transmitter.

In an example, the non-transitory computer-readable medium 602 includes instructions that cause the processing resource 604 to provide a virtual object, such as the virtual object 512, on an image having the user interface, such as the image 500. The virtual object corresponds to the object and a position of the virtual object on the image corresponds to a relative position of the object with respect to the HMD 603. Further, the instructions cause the processing resource 604 to determine whether the virtual menu button is actuated in response to an overlap between the position of the virtual object and a position of the virtual menu button, as explained with reference to FIG. 5.

The present subject matter provides an efficient feedback providing mechanism for HMDs. For instance, since the user is provided with a haptic feedback on actuation of menu options on a user interface, the user experience when interacting with simulated environments provided is enhanced. Further, since the position of the actuating object is tracked and the haptic feedback is directed towards the actuating object, the present subject matter ensures that haptic feedback is provided for a plurality of positions of the actuating object.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A head-mountable device (HMD) comprising:
a display device to provide a user interface, the user interface comprising a virtual menu button that is actuatable based on a position of an object;
a controller to determine if the virtual menu button is actuated; and
a feedback generator to provide a haptic feedback to the object in response to the determination that the virtual menu button is actuated.

2. The HMD of claim 1, wherein the display device comprises:
a screen to display an image comprising the user interface; and
a projection device to project the displayed image as a virtual image for view by a wearer of the HMD, wherein the virtual menu button on the virtual image is actuatable based on the position of the object.

3. The HMD of claim 1, comprising a camera to track a position of the object, wherein the controller is to:
determine a position of the object relative to the HMD based on data providable by the camera; and
determine if the virtual menu button is actuated based on the relative position.

4. The HMD of claim 1, comprising a distance sensor to determine a distance of the object with respect to the HMD and wherein the controller is to:
determine a position of the object relative to the HMD based on the distance of the object; and
determine if the virtual menu button is actuated based on the relative position.

5. The HMD of claim 1, wherein the display device is to:
provide an image comprising the user interface; and
display a virtual object corresponding to the object on the image, and wherein the controller is to:
adjust a position of the virtual object on a subsequent image provided by the display device based on a movement of the object relative to the HMD.

6. The HMD of claim 1, wherein the feedback generator comprises a plurality of ultrasonic transmitters distributed on a surface of the HMD that is to face the object and wherein the controller is to:
selectively activate an ultrasonic transmitter to provide the haptic feedback based on a position of the object relative to the HMD.

7. A wearable computing device comprising:
a screen to display an image having a user interface, the user interface comprising a virtual menu button;
a projection device to project the image as a virtual image, wherein the virtual menu button on the virtual image is actuatable based on a position of an object;
a feedback generator to generate an ultrasound signal to provide a haptic feedback to the object; and
a controller to instruct the feedback generator to provide the haptic feedback to the object in response to a determination that the virtual menu button has been actuated.

8. The wearable computing device of claim 7, wherein the controller is to:
receive an actuation indication from a host device; and
determine that the virtual menu button on the virtual image is actuated based on the actuation indication.

9. The wearable computing device of claim 8, comprising:
a distance sensor to determine a distance between the object and the wearable computing device; wherein the controller is to transmit the distance between the object and the wearable computing device to the host device for determination that the virtual menu button on the virtual image is actuated.

10. The wearable computing device of claim 8, comprising a camera to track movement of the object, wherein the controller is to transmit object images, the object images being images of the object captured by the camera, to the host device for determination that the virtual menu button on the virtual image is actuated.

11. A non-transitory computer-readable medium comprising instructions; the instructions being executable by a processing resource to:
determine a relative position of an object with respect to a head-mountable device (HMD) based on an object image, the object image being an image of the object captured by a camera of the HMD;
determine if a virtual menu button on a user interface provided by the HMD is actuated based on the relative position of the object with respect to the HMD; and
instruct a feedback generator of the HMD to provide a haptic feedback to the object in response to the determination that the virtual menu button is actuated.

12. The non-transitory computer-readable medium of claim 11, wherein the instructions are executable by the processing resource to:
receive, from a distance sensor of the HMD, a distance of the object from the HMD; and
determine the relative position of the object with respect to the HMD based on the distance of the object from the HMD.

13. The non-transitory computer-readable medium of claim 12, wherein the instructions are executable by the processing resource to determine whether the virtual menu button is actuated based on a change in distance of the object with respect to the HMD.

14. The non-transitory computer-readable medium of claim 11, wherein the instructions are executable by the processing resource to:
provide a virtual object on an image having the user interface, wherein the virtual object corresponds to the object and wherein a position of the virtual object on the image corresponds to the relative position of the object with respect to the HMD; and
determine whether the virtual menu button is actuated in response to an overlap between the position of the virtual object and a position of the virtual menu button.

15. The non-transitory computer-readable medium of claim 11, wherein the feedback generator comprises a plurality of ultrasonic transmitters distributed on a surface of the HMD that is to face the object and wherein, to instruct the feedback generator to provide the haptic feedback, the instructions are executable by the processing resource to:
selectively activate an ultrasonic transmitter to provide the haptic feedback based on a position of the object relative to the HMD.
